(19) United States
(12) Patent Application Publication
(10) Pub. No.: US 2026/0281869 A1
(43) Pub. Date: Sep. 17, 2026

(54) METHOD AND DEVICE FOR RESOURCE ALLOCATION FOR WI-FI AWARE COMMUNICATION

(71) Applicant: Samsung Electronics Co., Ltd., Suwon-si, Gyeonggi-do (KR)

(72) Inventors: Junyoung CHOI, Suwon-si (KR); Junsung KIM, Suwon-si (KR); Seungbeom SEO, Suwon-si (KR); Hyunseob OH, Suwon-si (KR); Buseop JUNG, Suwon-si (KR); Sehee HAN, Suwon-si (KR)

(21) Appl. No.: 19/472,841

(22) PCT Filed: Apr. 15, 2024
(86) PCT No.: PCT/KR2024/005003

§ 371 Date: Oct. 6, 2025

(30) Foreign Application Priority Data
Apr. 14, 2023 (KR) 10-2023-0049513

(51) Int. Cl. H04W 40/24

(52) U.S. Cl. CPC H04W 40/244

(57) ABSTRACT

A first station for performing Wi-Fi Aware communication according to an embodiment of the present disclosure comprises a transceiver and a processor. The processor may receive a first beacon during a first access point (AP) period in which the first station communicates with a first AP, and communicate with a second station during a first aware period in which the first station performs Wi-Fi Aware communication. The first AP period may be determined on the basis of a minimum required AP period (MRP). The MRP may be determined on the basis of the first beacon, a second beacon received by the second station from a second AP, and a margin slot. Various other embodiments are possible.

### CROSS-REFERENCE TO RELATED APPLICATION(S)

This application is a U.S. National Stage application under 35 U.S.C. § 371 of an International application number PCT/KR2024/005003, filed on Apr. 15, 2024, which is based on and claims priority of a Korean patent application number 10-2023-0049513, filed on Apr. 14, 2023, in the Korean Intellectual Property Office, the disclosure of which is incorporated by reference herein in its entirety.

### TECHNICAL FIELD

The disclosure relates to a resource allocation method for Wi-Fi Aware communication.

### BACKGROUND ART

The Internet, which is a human centered connectivity network where humans generate and consume information, is now evolving to the Internet of things (IoT) where distributed entities, such as things, exchange and process information. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation. Recently, a sensor network, a machine-to-machine (M2M) communication, machine type communication (MTC), and so forth have been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

Wi-Fi CERTIFIED Wi-Fi Aware™ (Wi-Fi Aware) is technology that facilitates prompt search, connection, and data exchange with another Wi-Fi device without conventional network infrastructures, Internet connection, or GPS signals, thereby extending Wi-Fi functions. Wi-Fi Aware may provide a function that enables devices to mutually search for their counterparts without another type of connection and to directly connect to each other. Wi-Fi Aware may be referred to as a neighbor awareness networking (NAN).

### DETAILED DESCRIPTION OF THE INVENTION

### Technical Problem

The disclosure proposes a method of allocating a time resource for Wi-Fi Aware communication.

### Technical Solution

According to an embodiment of the disclosure, a first station performing Wi-Fi Aware communication may include a transceiver and a processor. The processor may receive a first beacon in a first AP period in which the first station communicates with a first access point (AP), and may communicate with a second station in a first aware period in which the first station performs Wi-Fi Aware communication. The first AP period may be determined based on a minimum required AP period (MRP). The MRP may be determined based on the first beacon, a second beacon received by the second station from a second AP, and a margin slot.

According to an embodiment of the disclosure, a method of a first station performing Wi-Fi Aware communication may include an operation of receiving a first beacon in a first AP period in which the first station communicates with a first access point (AP), and an operation of communicating with a second station in a first aware period in which the first station performs Wi-Fi Aware communication. The first AP period is determined based on a minimum required AP period (MRP). The MRP may be determined based on the first beacon, a second beacon received by the second station from a second AP, and a margin slot.

### Advantageous Effects

A method and device according to an embodiment of the disclosure can efficiently adjust a time resource for AP communication and Wi-Fi Aware communication.

A method and device according to an embodiment of the disclosure may determine an efficient scheduling method during Wi-Fi Aware communication so as to prevent disconnection from an AP and increase communication efficiency.

### BRIEF DESCRIPTION OF DRAWINGS

FIG. 1 is a diagram illustrating a communication system including an access point and a station.

FIG. 2A is a diagram illustrating operation of an access point and a station for configuring a Wi-Fi connection.

FIG. 2B is a diagram illustrating operation of a first station and a second station for a Wi-Fi Aware connection.

FIG. 3 is a diagram illustrating time resource allocation for AP communication and Wi-Fi Aware communication of a station according to an embodiment of the disclosure.

FIG. 4A and FIG. 4B are diagrams illustrating a method of optimizing an AP period for AP communication according to an embodiment of the disclosure.

FIG. 5 is a diagram illustrating an example of an AP and Wi-Fi Aware scheduling method according to an embodiment of the disclosure.

FIG. 6 is a diagram illustrating another example of an AP and Wi-Fi Aware scheduling method according to an embodiment of the disclosure.

FIG. 7 is a diagram illustrating another example of an AP and Wi-Fi Aware scheduling method according to an embodiment of the disclosure.

FIG. 8 is a diagram illustrating another example of an AP and Wi-Fi Aware scheduling method according to an embodiment of the disclosure.

FIG. 9 is a diagram illustrating another example of an AP and Wi-Fi Aware scheduling method according to an embodiment of the disclosure.

FIG. 10 illustrates a structure of a station according to an embodiment of the disclosure.

FIG. 11 illustrates a structure of an access point according to an embodiment of the disclosure.

FIG. 12 illustrates an operation manner of a station according to an embodiment of the disclosure.

### MODE FOR CARRYING OUT THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, according to some embodiments, the “unit” may include one or more processors.

As used herein, the term “station (STA)” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various example of the station (STA) may include a cellular phone, a smartphone having a wireless communication function, a personal digital assistant (PDA) having a wireless communication function, a wireless modem, a portable computer having a wireless communication function, a photographing device, such as a digital camera, having a wireless communication function, a gaming device having a wireless communication function, a music storage and reproduction home appliance having a wireless communication function, an Internet home appliance capable of wireless Internet access and browsing, and portable units or terminals having integrated combinations of the above functions. Furthermore, the station (STA) may include a machine to machine (M2M) terminal, and a machine type communication (MTC) terminal/device, but is not limited thereto. As used herein, the station (STA) may also be referred to as an electronic device or simply as a device.

In the disclosure, “wireless local area network (WLAN)” and “Wi-Fi” are interchangeably used. In the disclosure, although, for ease of description, a description of a WLAN system including at least one access point (AP) and at least one station (STA) is provided, embodiments of the disclosure, for example, may be applicable to multiple WLANs, a peer to peer (or independent basic service set) system, Wi-Fi direct system, and/or another WLAN system including a hotspot.

Wi-Fi CERTIFIED Wi-Fi Aware™ (Wi-Fi Aware) is technology that facilitates prompt search, connection, data exchange with another Wi-Fi device without conventional network infrastructures, the Internet connection, or GPS signals, thereby extending Wi-Fi functions. Wi-Fi Aware may provide a function that enables devices to mutually search for their counterparts without another type of connection and to directly connect to each other. Wi-Fi Aware may be referred to as a neighbor awareness networking (NAN).

Wi-Fi Aware networking may form a cluster with neighboring devices or may generate a new cluster and operate when a device is a first device in an area. An application may communicate with a Wi-Fi Aware system service that manages Wi-Fi Aware hardware of a device by using a Wi-Fi Aware application programming interface (API). For example, a Wi-Fi Aware network connection may support a higher processing rate in a long distance beyond the reach of Bluetooth connection. For example, the Wi-Fi Aware network connection may be usefully utilized for an app that shares a large amount of data among users such as a photo-sharing app.

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

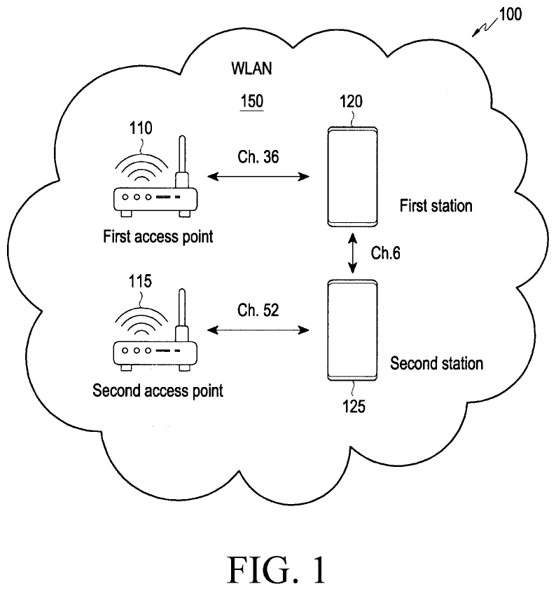

FIG. 1 is a diagram illustrating a communication system 100 including an access point (AP) and a station (STA).

Referring to FIG. 1, the communication system 100 may include a wireless local area network (WLAN) 150 configured with a plurality of radio access points (AP) 110 and 115 and a plurality of stations (STAs) 120 and 125. For ease of description, although FIG. 1 illustrates only two access points (APs) 110 and 115 and two stations (STAs) 120 and 125, the WLAN 150 may include a predetermined number of access points (APs) and a predetermined number of stations (STAs).

The stations (STA) 120 and 125 may include at least one transceiver, at least one processor, and/or at least one memory. The at least one memory may include a non-transitory computer-readable recording medium storing instructions which cause the access point (AP) 110 or 115 to perform operations according to the embodiments of the disclosure.

The access point (AP) 110 or 115 may be a device that enables one or more stations (STAs) to access a network (e.g., a local area network (LAN), a wide area network (WAN), a metropolitan area network (MAN), and/or the Internet) by using Wi-Fi, Bluetooth, or other predetermined proper communication technologies. The access point (AP) 110 or 115 may include at least one transceiver, at least one processor, and/or at least one memory. The at least one memory may include a non-transitory computer-readable recording medium storing instructions which cause the access point (AP) 110 or 115 to perform operations according to the embodiments of the disclosure. According to an embodiment, the access point (AP) 110 or 115 may be embodied as a hardware device or a software device.

The at least one transceiver included in the access point (AP) 110 or 115 and/or station (STA) 120 or 125 may include a Wi-Fi transceiver, a Bluetooth transceiver, a cellular transceiver, and/or other proper radio frequency (RF) transceivers for transmitting and/or receiving a signal. Respective transceivers may communicate with different wireless devices in separate operating frequency bands and/or using separate communication protocols. For example, the Wi-Fi transceiver may perform communication within the 2.4 GHz frequency band and/or 5 GHz frequency band according to the IEEE 802.11 standard.

The first station 120 may be connected to the first access point 110 via a first channel (e.g., channel No. 36 of 5 GHz) and the second station 125 may be connected to the second access point 115 via a second channel (e.g., channel No. 52 of 5 GHz). The first station 120 may have a Wi-Fi Aware (or NAN) connection with the second station 125 via a third channel (e.g., channel No. 6 of 2 GHz).

In the disclosure, a channel that the station 120 or 125 uses when communicating with the access point 110 or 115 may be referred to as an AP channel, and a channel used for communication between the stations 120 and 125 may be referred to as a Wi-Fi Aware channel (or aware channel).

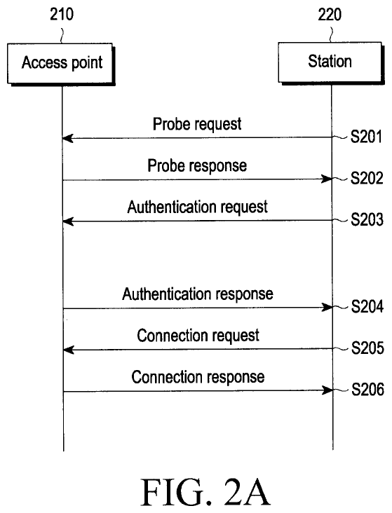

FIG. 2A is a diagram illustrating operation of an access point (AP) and a station (STA) for configuring a Wi-Fi connection.

Referring to FIG. 2A, the station 220 may transmit or broadcast a probe request message to the access point 210 in operation S201. For example, the probe request message may include information related to at least one communication capability supported by the station 220.

The access point 210 may transmit a probe response message in response to the probe request message in operation S202. When the probe response message is received, the station 220 may transmit an authentication request message to the access point 210 in operation S203. The access point 210 may transmit an authentication response message to the station 220 in response to the authentication request message in operation S204, and an authentication procedure between the access point 210 and the station 220 may be completed.

When the authentication procedure is completed, the station 220 may transmit a connection (association) request message to the access point 210 in operation S205. For example, the connection request message may include information related to at least one capability (e.g., according to the IEEE 802.11 standard) to be used for data communication between the station 220 and the access point 210. The access point 210 may generate an association ID for the station 220, and may transmit a connection response message to the station 220 in operation S206.

FIG. 2B is a diagram illustrating operation of a first station and a second station for a Wi-Fi Aware connection.

Referring to FIG. 2B, when a first station 230 and a second station 240 determine to perform Wi-Fi Aware (or NAN) connection, the first station 230 may transmit at least one discovery beacon message to the second station 240 for synchronization in operations S211 and S212. The first station 230 may transmit a synchronization beacon message to the second station 240 in operation S213. The second station 240 may scan at least one discovery beacon message and a synchronization beacon message, and may perform synchronization with the first station 230.

The first station 230 may transmit a service discovery frame (SDF) publish message to the second station 240 for service discovery in operation S214, and the second station 240 may transmit an SDF follow-up message corresponding to the SDF publish to the first station 230 in operation S215.

The second station 240 may transmit a data path request message to the first station 230 for NAN data path (NDP) setup in operation S216, and the first station 230 may transmit a data path response message to the second station 240 in operation S217. The second station 240 may transmit a data path confirm message to the first station 230 in operation S218, and the first station 230 may transmit a data path key installment message to the second station 240 in operation S219.

When the NDP setup is completed, the first station 230 and the second station 240 may establish an NAN connection in operation S220.

According to an embodiment, the first station 230 and the second station 240 may exchange information related to quality of service (QoS) before an NDP setup procedure. According to an embodiment, the information related to the QoS may be included in a QoS field of an SDF message (e.g., SDF publish message, SDF subscribe message, and/or SDF follow-up message).

According to an embodiment, the first station 230 and the second station 240 may exchange time synchronization function (TSF) information in a service discovery procedure (e.g., operation S214 and/or operation S215) in order to optimize AP and Wi-Fi Aware scheduling. According to an embodiment, the first station 230 and/or second station 240 may adjust and/or decrease an AP period (or period) for communication with an access point (AP) by using the exchanged TSF information. For example, based on the TSF information, the AP period may be decreased from 8 slots to 5 slots.

According to an embodiment, when, during communication with an access point, both the first station 230 and the second station 240 do not transmit and/or receive traffic that requires high QoS, a larger amount of time resource may be allocated to Wi-Fi Aware communication between the first station 230 and the second station 240. According to an embodiment, the first station 230 and the second station 240 may perform one-hop data transmission (e.g., QuickShare function).

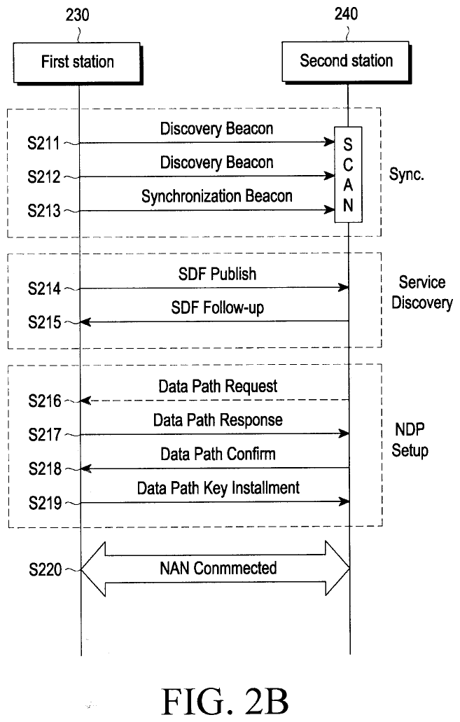

FIG. 3 is a diagram illustrating time resource allocation for AP communication and Wi-Fi Aware communication of a station according to an embodiment of the disclosure.

Referring to FIG. 3, a communication system may include a first access point 310, a first station 320 connected to the first access point 310, a second access point 315, and a second station 325 connected to the second access point 315. In this instance, the first station 320 and the second station 325 may perform Wi-Fi Aware communication.

The first access point 310 may broadcast a plurality of beacons 301, 303, 305, 307, 309, or 311 via a first AP channel (e.g., channel No. 36) and the second access point 2 315 may broadcast a plurality of beacons 321, 323, 325, 327, and 329 via a second AP channel (e.g., channel No. 52). In the disclosure, a beacon broadcasted by the access point may be referred to as an AP beacon.

The first access point 310 may broadcast each of the plurality of beacons 301, 303, 305, 307, 309, and 311 based a configured period (e.g., 100 time units (TU)) via the first AP channel (e.g., channel No. 36). The second access point 2 315 may broadcast each of the plurality of beacons 321, 323, 325, 327, and 329 based a configured period (e.g., 100 time units (TU)) via the second AP channel (e.g., channel No. 52). For example, a time interval between a beacon broadcasted by the first access point 310 and a beacon broadcasted by the second access point 2 315 may be configured to 50 TU.

According to an embodiment, a beacon broadcasted by the first access point 310 and/or second access point 315 may include at least one from among identification information such as a service set identifier (SSID) or a basic service set identifier (BSSID), frequency information related to data transmission or reception, and frequency type information.

According to an embodiment, 1 slot that is a time resource allocation unit for AP communication and Wi-Fi Aware communication may be configured to 16 TU. In FIG. 3, 8 slots (128 TU) may be allocated to each AP period 340 or 343 for AP communication, and 8 slots (128 TU) may be allocated to each aware period 341 or 345 for Wi-Fi Aware communication.

The first station 320 may receive two beacons 301 and 303 that the first access point 310 broadcasts during the first AP period 340. The first station 320 may perform Wi-Fi Aware communication with the second station 325 during the first aware period 341, and may fail to receive one beacon 305 broadcasted by the first access point 310.

The first station 320 may receive one beacon 307 that the first access point 310 broadcasts during the second AP period 343. The first station 320 may perform Wi-Fi Aware communication with the second station 325 during the second aware period 345, and may fail to receive two beacons 309 and 311 broadcasted by the first access point 310.

The second station 325 may receive one beacon 321 or 303 that the second access point 315 broadcasts during the first AP period 340. The second station 325 may perform Wi-Fi Aware communication with the first station 320 during the first aware period 341, and may fail to receive two beacons 323 and 325 broadcasted by the second access point 315.

The second station 325 may receive one beacon 327 that the second access point 315 broadcasts during the second AP period 343. The second station 325 may perform Wi-Fi Aware communication with the first station 320 during the second aware period 345, and may fail to receive one beacon 329 broadcasted by the second access point 315.

In FIG. 3, each of the first station 320 and the second station 325 may fail to receive one or two AP beacons during the Wi-Fi Aware communication. The disclosure proposes a method of decreasing an AP period and increasing a Wi-Fi Aware period in consideration of the number of times that the first station 320 and the second station 325 fail to receive an AP beacon.

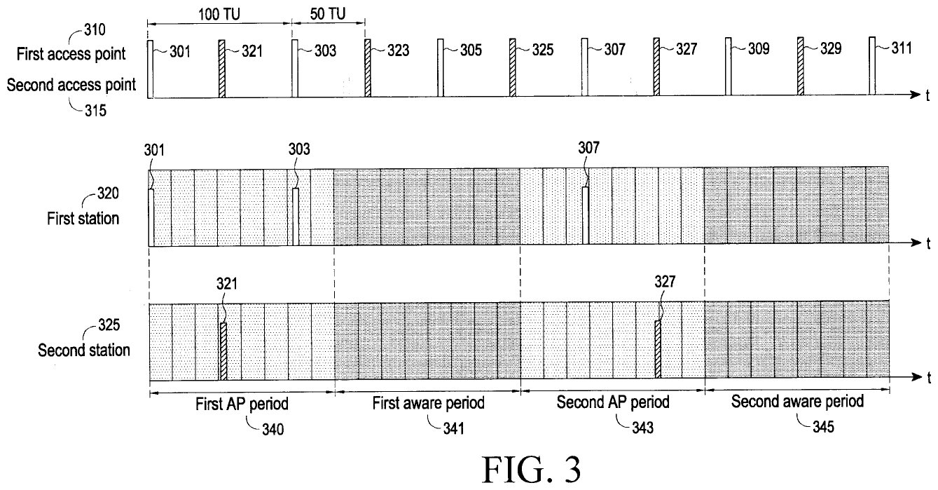

FIG. 4A and FIG. 4B are diagrams illustrating a method of optimizing an AP period for AP communication according to an embodiment of the disclosure.

The disclosure may propose a calculation method for minimizing the number of slots allocated to an AP period. According to an embodiment, a first station may receive a first beacon from a first access point in an AP period, and a second station may receive a second beacon from a second access point in the same AP period.

A time period from a reference time to a time at which a target beacon that a predetermined access point broadcasts is transmitted (or received) may be defined as a target beacon transmission time (TBTT). For example, a TBTT for a target beacon that an i^{th} access point transmits is defined as TBTTᵢ, and a TBTT for a target beacon that a j^{th} access point transmits is defined as TBTTⱼ.

A time gap between a beacon that the first access point broadcasts and a beacon that the second access point broadcasts may be defined as a time gap between beacon (TGBB). For example, a time gap between a target beacon that the i^{th} access point transmits and a target beacon that the j^{th} access point transmits is defined as TGBBᵢⱼ.

A single AP period for AP communication is configured to 1 slot (=16 TU), and a time interval between a first beacon that the first access point broadcasts and a second beacon that the second access point broadcasts is configured to a maximum of 50 TU. In this instance, in the single AP period, a slot unit based time period from a slot in which the first beacon is transmitted (or received) to a slot in which the second beacon is transmitted (or received) may be defined as an overlapped slot period (overlapped slots).

According to an embodiment, when a time gap between a first beacon that the i^{th} access point transmits and a second beacon that the j^{th} access point transmits is TGBBᵢⱼ, an overlapped slot period (overlapped slots) may be determined based on the equation of

$$⌈ \frac{{TGBB}_{ij}}{16 TU} ⌉ .$$

For example, when the time interval between the first beacon and the second beacon is configured to 50 TU, the overlapped slot period (overlapped slots) may be configured to 4 slots

$$( ⌈ \frac{50 TU}{16 TU} ⌉ ) .$$

According to an embodiment, when the time interval between the first beacon that the i^{th} access point transmits and the second beacon that the j^{th} access point transmits is configured to a maximum of 50 TU, the overlapped slot period (overlapped slots) may be configured to a maximum of 4 slots. According to an embodiment, when |TGBBᵢⱼ|>50 TU is satisfied, 100 TU may be added to a smaller TBTT.

In the disclosure, a minimum required AP period in units of slots, which is required for each of the first station and the second station to receive a beacon from an AP, may be defined as a minimum required AP period (MRP). The MRP may be determined based on Equation 1 provided below.

$$MRP = overlapped slot period ( overlapped slots ) + margin slot \qquad Equation 1$$

The margin slot is a slot obtained in consideration of a time spent in channel switching between a Wi-Fi Aware period and an AP period, and may be configured, for example, to 1 slot. According to an embodiment, the margin slot may be configured to various numbers of slots.

According to an embodiment, when the margin slot is 1, the MRP may be determined based on a calculation result of

$$⌈ \frac{{TGBB}_{ij}}{16 TU} ⌉ + 1.$$

According to an embodiment, the MRP may be configured to a maximum of 5 slots (=80 TU). For example, when the overlapped slot period (overlapped slots) is 4 slots, and the margin slot is configured to 1 slot, the MRP may be determined to be 5 slots.

Referring to FIG. 4A, the first station may receive a first beacon 401 from the first access point in an AP period, and the second station may receive a second beacon 403 from the second access point in the same AP period. In this instance, TBTT₁ for the first beacon 401 that the first access point transmits and TBTT₂ for the second beacon 403 that the second access point transmits may be determined, and TGBB₁₂ for the first beacon 401 and the second beacon 403 may be determined. In FIG. 4A, based on the TGBB₁₂, an overlapped slot period (overlapped slots) may be determined to be 4 slots. In this instance, the overlapped slot period (overlapped slots) is 4 slots and a margin slot is 1 slot, and thus an MRP may be determined to be 5 slots. Therefore, in FIG. 4A, the minimum required AP period for the stations to receive target beacons may be determined to be 5 slots.

Referring to FIG. 4B, the first station may receive a first beacon 405 from the first access point in an AP period, and the second station may receive a second beacon 407 from the second access point in the same AP period. In this instance, TBTTᵢ for the first beacon 405 that the first access point transmits and TBTT₂ for the second beacon 407 that the second access point transmits may be determined, and TGBB₁₂ for the first beacon 405 and the second beacon 407 may be determined. In FIG. 4B, based on the TGBB₁₂, an overlapped slot period (overlapped slots) may be determined to be 1 slot. In this instance, the overlapped slot period (overlapped slots) is 1 slot and a margin slot is 1 slot, and thus an MRP may be determined to be 2 slots. Therefore, in FIG. 4B, the minimum required AP period for the stations to receive target beacons may be determined to be 2 slots.

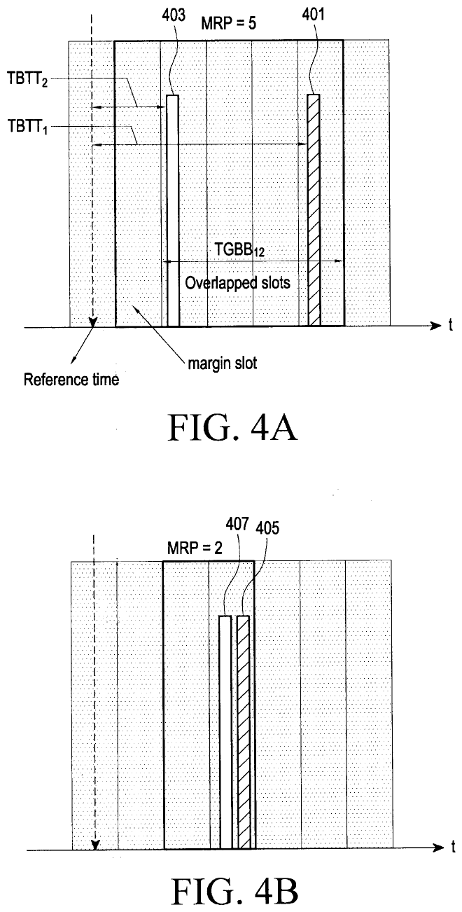

FIG. 5 is a diagram illustrating an example of an AP and Wi-Fi Aware scheduling method according to an embodiment of the disclosure.

Referring to FIG. 5, a communication system may include a first access point 510, a first station 520 connected to the first access point 510, a second access point 514, and a second station 524 connected to the second access point 514. In this instance, the first station 520 and the second station 524 may perform Wi-Fi Aware communication.

The first access point 510 may broadcast a plurality of beacons 501 to 525 via a first AP channel (e.g., channel No. 36) and the second access point 2 514 may broadcast a plurality of beacons 531 to 557 via a second AP channel (e.g., channel No. 52).

The first access point 510 may broadcast each of the plurality of beacons 501 to 525 based a configured period (e.g., 100 time units (TU)) via the first AP channel (e.g., channel No. 36). The second access point 2 514 may broadcast each of the plurality of beacons 531 to 557 based a configured period (e.g., 100 time units (TU)) via the second AP channel (e.g., channel No. 52). For example, a time interval between a beacon that the first access point 510 broadcasts and a beacon that the second access point 2 514 broadcasts may be configured to 50 TU.

According to an embodiment, 1 slot that is a time resource allocation unit for AP communication and Wi-Fi Aware communication may be configured to 16 TU. In FIG. 5, 5 slots (=80 TU) may be allocated to each AP period 561, 565, 569, 573, or 577 for AP communication. An MRP for each AP period 561, 565, 569, 573, or 577 may be configured to 5 slots.

For some aware periods 563, 567, and 571 for Wi-Fi Aware communication, 14 slots (=224 TU) may be allocated to each period, and for some aware periods 575 for Wi-Fi Aware communication, 13 slots (=208 TU) may be allocated to each period. In FIG. 5, a total of 608 TU may be expended for performing channel switching four times.

The first station 520 may receive one beacon 501 that the first access point 510 broadcasts during the first AP period 561. The first station 520 may perform Wi-Fi Aware communication with the second station 524 during the first aware period 563, and may fail to receive two beacons 503 and 505 broadcasted by the first access point 510.

The first station 320 may receive one beacon broadcasted by the first access point 510 in each of the second AP period 565, the third AP period 569, the fourth AP period 573, and the fifth AP period 577. The first station 320 may perform Wi-Fi Aware communication with the second station 524 in each of the second AP period 567, the third AP period 571, and the fourth AP period 575, and may fail to receive beacons that the first access point 510 broadcasts.

The second station 524 may receive one beacon 531 that the second access point 514 broadcasts during the first AP period 561. The second station 524 may perform Wi-Fi Aware communication with the first station 520 during the first aware period 563, and may fail to receive two beacons 533 and 535 broadcasted by the second access point 514.

The second station 524 may receive one beacon 537 that the second access point 514 broadcasts during the second AP period 565. According to an embodiment, a total of 304 TU is allocated to a first round including the first AP period 561 and the first aware period 563 but an interval between beacons transmitted by each access point 510 or 514 is 100 TU, and thus the second station 524 may be shifted by 4 TU from an ideal beacon reception point 537-1 during the second AP period 565 and may receive the beacon 537 in advance. The second station 524 may perform Wi-Fi Aware communication with the first station 520 during the second aware period 567, and may fail to receive two beacons 539 and 541 broadcasted by the second access point 514.

The second station 524 may receive one beacon 543 that the second access point 514 broadcasts during the third AP period 569. According to an embodiment, the second station 524 may be shifted by 8 TU from an ideal beacon reception point 543-1 during the third AP period 569 and may receive the beacon 543 in advance. The second station 524 may perform Wi-Fi Aware communication with the first station 520 during the third aware period 567, and may fail to receive two beacons 545 and 547 broadcasted by the second access point 514.

The second station 524 may receive one beacon 549 that the second access point 514 broadcasts during the fourth AP period 573. According to an embodiment, the second station 524 may be shifted by 12 TU from an ideal beacon reception point 549-1 during the fourth AP period 573 and may receive the beacon 549 in advance. The second station 524 may perform Wi-Fi Aware communication with the first station 520 during the fourth aware period 575, and may fail to receive two beacons 551 and 553 broadcasted by the second access point 514.

The second station 524 may receive one beacon 555 that the second access point 514 broadcasts during the fifth AP period 577 without a shift.

Referring to FIG. 5, the first station 520 and/or the second station 524 may fail to receive two beacons during a predetermined aware period, and may receive a beacon shifted in time in a predetermined AP period. For example, the probability of failing to receive consecutively three beacons in the MRP of FIG. 5 may be implemented as 0.1% (e.g., (9 consecutive AP beacons)≈0.001 (0.1%)).

In the disclosure, the size of an AP period (e.g., the number of slots of an AP period) allocated to a station may be configured and/or adjusted based on the MRP value. In addition, in the disclosure, the size of an aware period (e.g., the number of slots of an aware period) allocated to a station may be configured and/or adjusted based on the MRP value and an N value. In this instance, the N may be the number of AP beacons skippable by a station. According to an embodiment, the N may be determined based on an AP connection policy (or AP connection loss policy) for a station.

According to an embodiment, a station may receive an AP beacon at every N+1 interval. According to an embodiment, an interval of one ideal round (AP period+aware period) may be configured to (N+1)*100 TU.

According to an embodiment, the number (rₛ) of slots in one round may be determined based on Equation 2 as given below.

$$( {r}_{s} ) = ⌈ ( N + 1 ) * \frac{100}{16} ⌉ \qquad Equation 2$$

According to an embodiment, a beacon shifting value (ε) for a predetermined AP beacon may be determined based on Equation 3 as given below.

$$( ε ) = mod ( ( N + 1 ) * 100 , 16 ) , ε = \{ 0 , 4 , 8 , 12 \} \qquad Equation 3$$

According to an embodiment, when MRP=5 and N=3, ε=0 and rₛ=25 are determined based on Equation 2 and Equation 3, and the number of slots in the repeated aware period may be determined to be 20 (rₛ(S)=[rₛ]=[20]).

According to an embodiment, when MRP=5 and N=2, ε=4 and rₛ=19 are determined based on Equation 2 and Equation 3, and the number of slots in the repeated aware period may be determined to be S=[rₛ, rₛ, rₛ, rₛ−1].

According to an embodiment, when MRP=5 and N=1, ε=8 and rₛ=19 are determined based on Equation 2 and Equation 3, and the number of slots in the repeated aware period may be determined to be S=[rₛ, rₛ−1].

According to an embodiment, when MRP=5 and N=4, ε=12 and rₛ=32 are determined based on Equation 2 and Equation 3, and the number of slots in the repeated aware period may be determined to be S=[rₛ, rₛ−1, rₛ−1, rₛ−1].

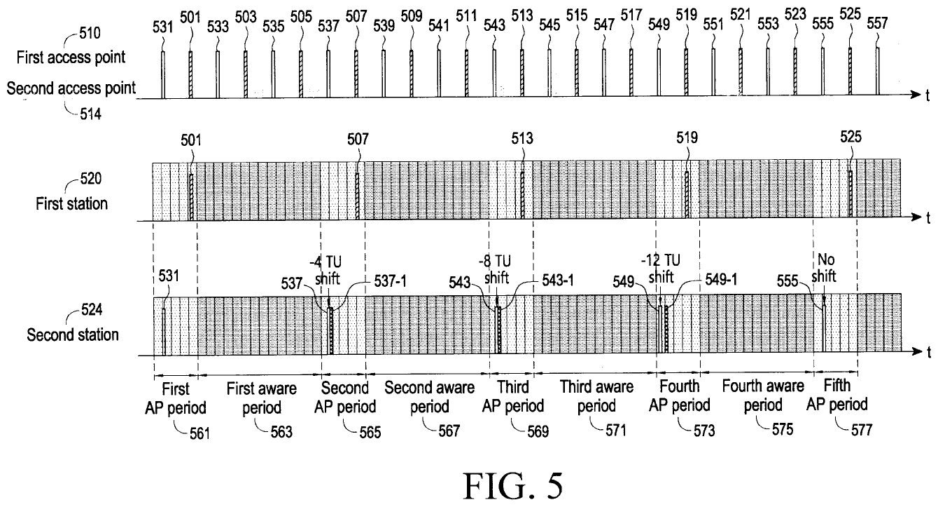

FIG. 6 is a diagram illustrating another example of an AP and Wi-Fi Aware scheduling method according to an embodiment of the disclosure.

Referring to FIG. 6, a communication system may include a first access point 610, a first station 620 connected to the first access point 610, a second access point 614, and a second station 624 connected to the second access point 614. In this instance, the first station 620 and the second station 624 may perform Wi-Fi Aware communication.

The first access point 610 may broadcast a plurality of beacons 601 to 619 via a first AP channel (e.g., channel No. 36) and the second access point 2 614 may broadcast a plurality of beacons 621 to 641 via a second AP channel (e.g., channel No. 52).

The first access point 610 may broadcast each of the plurality of beacons 601 to 619 based a configured period (e.g., 100 time units (TU)) via the first AP channel (e.g., channel No. 36). The second access point 614 may broadcast each of the plurality of beacons 621 to 641 based a configured period (e.g., 100 time units (TU)) via the second AP channel (e.g., channel No. 52). For example, a time interval between a beacon that the first access point 610 broadcasts and a beacon that the second access point 614 broadcasts may be configured to 50 TU.

According to an embodiment, 1 slot that is a time resource allocation unit for AP communication and Wi-Fi Aware communication may be configured to 16 TU. In FIG. 6, 5 slots (=80 TU) may be allocated to each AP period 651, 655, or 659 for AP communication. An MRP for each AP period 651, 655, or 659 may be configured to 5 slots. In FIG. 6, an N value for a predetermined station may be configured to 3.

20 slots (=320 TU) may be allocated to each aware period 653 and 657 for Wi-Fi Aware communication. In FIG. 6, a total of 800 TU may be expended for performing channel switching four times, and beacon shifting may not occur.

The first station 620 may receive one beacon 601 that the first access point 610 broadcasts during the first AP period 651. The first station 620 may perform Wi-Fi Aware communication with the second station 624 during the first aware period 653, and may fail to receive three beacons 603, 605, and 607 broadcasted by the first access point 610.

The first station 620 may receive one beacon that the first access point 610 broadcasts in each of the second AP period 655 and the third AP period 659. The first station 620 may perform Wi-Fi Aware communication with the second station 624 during the second aware period 657, and may fail to receive three beacons 611, 613, and 615 broadcasted by the first access point 610.

The second station 624 may receive one beacon 621 that the second access point 620 broadcasts during the first AP period 651. The second station 624 may perform Wi-Fi Aware communication with the first station 620 during the first aware period 653, and may fail to receive three beacons 623, 625, and 627 broadcasted by the second access point 614.

The second station 624 may receive one beacon that the second access point 614 broadcasts in each of the second AP period 655 and the third AP period 659. The second station 624 may perform Wi-Fi Aware communication with the first station 620 during the second aware period 657, and may fail to receive three beacons 631, 633, and 635 broadcasted by the second access point 614.

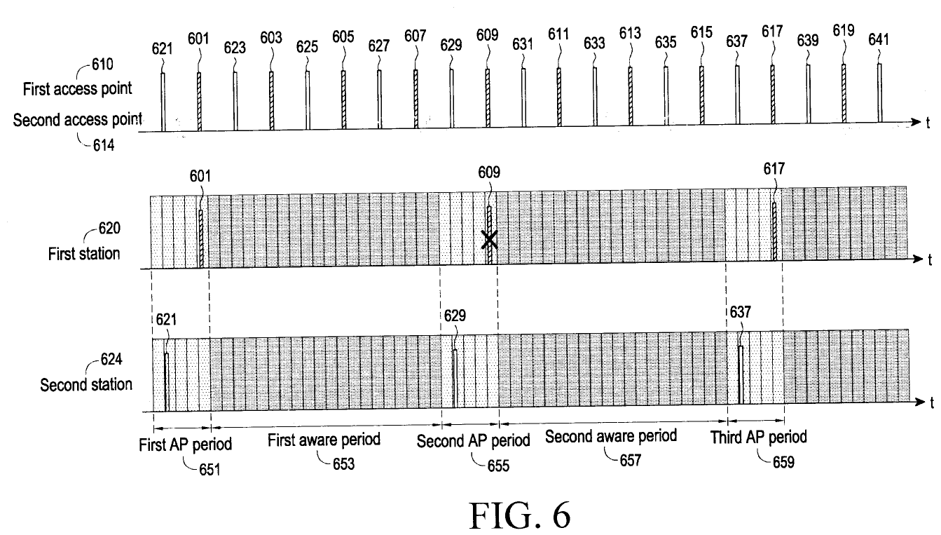

FIG. 7 is a diagram illustrating another example of an AP and Wi-Fi Aware scheduling method according to an embodiment of the disclosure.

Referring to FIG. 7, a communication system may include a first access point 710, a first station 720 connected to the first access point 710, a second access point 714, and a second station 724 connected to the second access point 714. In this instance, the first station 720 and the second station 724 may perform Wi-Fi Aware communication.

The first access point 710 may broadcast a plurality of beacons 701 to 721 via a first AP channel (e.g., channel No. 36) and the second access point 2 714 may broadcast a plurality of beacons 723 to 743 via a second AP channel (e.g., channel No. 52).

The first access point 710 may broadcast each of the plurality of beacons 701 to 721 based a configured period (e.g., 100 time units (TU)) via the first AP channel (e.g., channel No. 36). The second access point 714 may broadcast each of the plurality of beacons 723 to 743 based a configured period (e.g., 100 time units (TU)) via the second AP channel (e.g., channel No. 52).

In FIG. 7, 2 slots (=32 TU) may be allocated to each AP period 751, 755, or 759 for AP communication. An MRP for each AP period 751, 755, or 759 may be configured to 2 slots. In FIG. 7, an N value for a predetermined station may be configured to 3. 23 slots (=368 TU) may be allocated to each aware period 753 and 757 for Wi-Fi Aware communication.

The first station 720 may receive one beacon 701 that the first access point 710 broadcasts during the first AP period 751. The first station 720 may perform Wi-Fi Aware communication with the second station 724 during the first aware period 753, and may fail to receive three beacons 703, 705, and 707 broadcasted by the first access point 710.

The first station 720 may receive one beacon that the first access point 710 broadcasts in each of the second AP period 755 and the third AP period 759. The first station 720 may perform Wi-Fi Aware communication with the second station 724 during the second aware period 757, and may fail to receive three beacons 711, 713, and 715 broadcasted by the first access point 710.

The second station 724 may receive one beacon 723 that the second access point 720 broadcasts during the first AP period 751. The second station 724 may perform Wi-Fi Aware communication with the first station 720 during the first aware period 753, and may fail to receive three beacons 725, 727, and 729 broadcasted by the second access point 714.

The second station 724 may receive one beacon that the second access point 714 broadcasts in each of the second AP period 755 and the third AP period 759. The second station 724 may perform Wi-Fi Aware communication with the first station 720 during the second aware period 757, and may fail to receive three beacons 733, 735, and 737 broadcasted by the second access point 714.

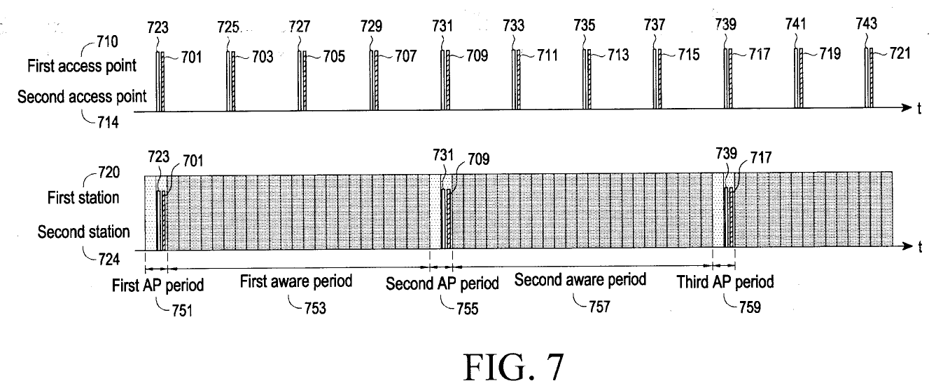

FIG. 8 is a diagram illustrating another example of an AP and Wi-Fi Aware scheduling method according to an embodiment of the disclosure.

Referring to FIG. 8, a communication system may include a first access point 810, a first station 820 connected to the first access point 810, a second access point 814, and a second station 824 connected to the second access point 814. In this instance, the first station 820 and the second station 824 may perform Wi-Fi Aware communication.

The first access point 810 may broadcast a plurality of beacons 801 to 813 via a first AP channel (e.g., channel No. 36) and the second access point 2 814 may broadcast a plurality of beacons 821 to 833 via a second AP channel (e.g., channel No. 52).

In FIG. 8, 5 slots (=80 TU) may be allocated to each AP period 841, 845, 849 or 853 for AP communication. An MRP for each AP period 841, 845, 849, or 853 may be configured to 5 slots. In FIG. 8, an N value for a predetermined station may be configured to 1. 8 slots (=128 TU) may be allocated to each aware period 843, 847, or 851 for Wi-Fi Aware communication. In FIG. 8, 400 TU may be expended for performing channel switching four times, which alternately switches between an AP channel and a Wi-Fi Aware channel.

The first station 820 may receive one beacon 801 that the first access point 810 broadcasts during the first AP period 841. The first station 820 may perform Wi-Fi Aware communication with the second station 824 during the first aware period 843, and may fail to receive one beacon 803 broadcasted by the first access point 810.

The first station 820 may receive one beacon that the first access point 810 broadcasts in each of the second AP period 845 and the third AP period 849. The first station 820 may perform Wi-Fi Aware communication with the second station 824 during the second aware period 847, and may fail to receive one beacon 807 broadcasted by the first access point 810.

The second station 824 may receive one beacon 821 that the second access point 820 broadcasts during the first AP period 841. The second station 824 may perform Wi-Fi Aware communication with the first station 820 during the first aware period 843, and may fail to receive one beacon 823 broadcasted by the second access point 814.

The second station 824 may receive a beacon 825 that is shifted by 8 TU and broadcasted by the second access point 814 during the second AP period 845. The second station 824 may perform Wi-Fi Aware communication with the first station 820 during the second aware period 847, and may fail to receive one beacon 827 broadcasted by the second access point 814. The second station 824 may receive a beacon 829 that not shifted and is broadcasted by the second access point 814 during the third AP period 849.

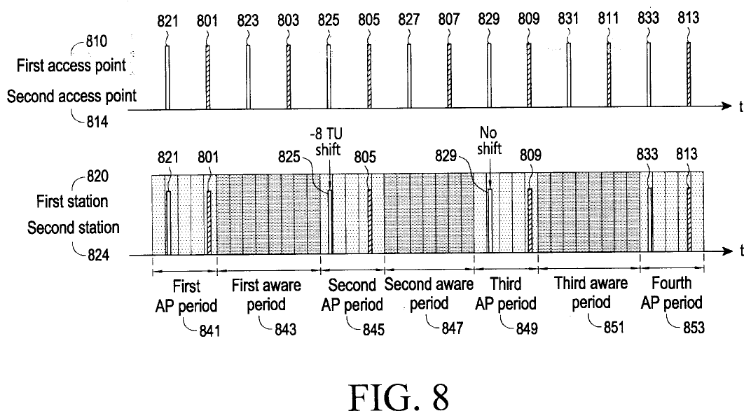

FIG. 9 is a diagram illustrating another example of an AP and Wi-Fi Aware scheduling method according to an embodiment of the disclosure.

Referring to FIG. 9, a communication system may include a first access point 910, a first station 920 connected to the first access point 910, a second access point 914, and a second station 924 connected to the second access point 914. In this instance, the first station 920 and the second station 924 may perform Wi-Fi Aware communication.

The first access point 910 may broadcast a plurality of beacons 901 to 913 via a first AP channel (e.g., channel No. 36) and the second access point 2 914 may broadcast a plurality of beacons 914 to 933 via a second AP channel (e.g., channel No. 52).

In FIG. 9, 2 slots (=16 TU) may be allocated to each AP period 941, 945, 949 or 953 for AP communication. An MRP for each AP period 941, 945, 949, or 953 may be configured to 2 slots. In FIG. 9, an N value for a predetermined station may be configured to 1. 11 slots (=176 TU) may be allocated to each aware period 943, 947, or 951 for Wi-Fi Aware communication.

The first station 920 may receive one beacon 901 that the first access point 910 broadcasts during the first AP period 941. The first station 920 may perform Wi-Fi Aware communication with the second station 924 during the first aware period 943, and may fail to receive one beacon 903 broadcasted by the first access point 910.

The first station 920 may receive one beacon that the first access point 910 broadcasts in each of the second AP period 945 and the third AP period 949. The first station 920 may perform Wi-Fi Aware communication with the second station 924 during the second aware period 947, and may fail to receive one beacon 907 broadcasted by the first access point 910.

The second station 924 may receive one beacon 921 that the second access point 920 broadcasts during the first AP period 941. The second station 924 may perform Wi-Fi Aware communication with the first station 920 during the first aware period 943, and may fail to receive one beacon 923 broadcasted by the second access point 914.

The second station 924 may receive a beacon 925 that is shifted by 8 TU and broadcasted by the second access point 914 during the second AP period 945. The second station 924 may perform Wi-Fi Aware communication with the first station 920 during the second aware period 947, and may fail to receive one beacon 927 broadcasted by the second access point 914. The second station 924 may receive a beacon 929 that is not shifted and is broadcasted by the second access point 914 during the third AP period 949.

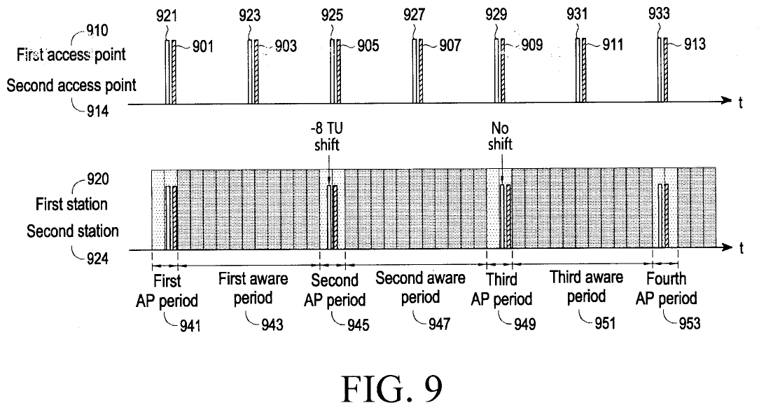

FIG. 10 is a diagram illustrating the structure of a station according to an embodiment of the disclosure.

The station of FIG. 10 may be embodied as a station, a first station, or a second station as illustrated in FIGS. 1 to 9.

Referring to FIG. 10, the station may include a processor 1001, a transceiver 1003, and memory 1005. In the disclosure, the processor 1001 may be defined as a circuit or application-specific integrated circuit, or at least one processor. The processor 1001 may be referred to as a controller.

The processor 1001 may control the overall operation of the station according to embodiments proposed in the disclosure. Specifically, the processor 1001, for example, may control operation of the station illustrated in FIGS. 1 to 9.

The transceiver 1003 may transmit or receive a signal to or from another station or an access point.

The memory 1005 may store at least one piece of information among information transmitted or received via the transceiver 1003 and information produced by the processor 1001.

According to an embodiment, the processor 1001 may receive a first beacon during a first access point (AP) period in which a first station communicates with a first access point (AP). According to an embodiment, the processor 1001 may communicate with a second station in a first aware period in which the first station performs Wi-Fi Aware communication. According to an embodiment, the first AP period may be determined based on a minimum required AP period (MRP). According to an embodiment, the MRP may be determined based on the first beacon, a second beacon that the second station receives from a second AP, and a margin slot.

According to an embodiment, the MRP may be determined based on a difference in time between a transmission point of the first beacon and a transmission point of the second beacon.

According to an embodiment, the margin slot may be determined based on a time expended when the first station performs channel switching between an AP channel and a Wi-Fi Aware channel.

According to an embodiment, the first aware period may be determined based on the MRP and an N value. According to an embodiment, the N value may be the number of beacons skippable by the first station among a plurality of beacons transmitted from the first AP during a predetermined time period. According to an embodiment, the N value may be configured based on a connection policy of the first AP or the second AP.

According to an embodiment, based on the N value, the number of slots in a round including the first AP period and the first aware period may be determined. According to an embodiment, based on the number of slots in the round and the MRP, the number of slots in the first aware period may be determined.

According to an embodiment, the processor 1001 may receive a third beacon during a second AP period in which the first station communicates with the first AP. According to an embodiment, the processor 1001 may communicate with the second station in a second aware period in which the first station performs Wi-Fi Aware communication.

According to an embodiment, the first AP period and the second AP period may be configured to a first slot value, and the first aware period and the second aware period may be configured to a second slot value.

According to an embodiment, the first AP period and the second AP period may be configured to the first slot value, the first aware period may be configured to the second slot value, and the second aware period may be configured to a third slot value. According to an embodiment, the second slot value and the third slot value may be determined based on a beacon shifting value for at least one beacon.

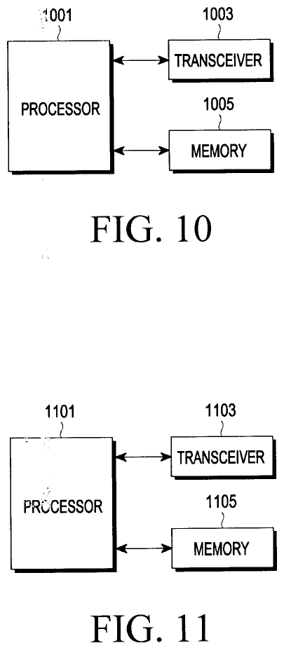

FIG. 11 is a diagram illustrating the structure of an access point according to an embodiment of the disclosure.

The access point of FIG. 11 may be embodied as an access point, a first access point, or a second access point illustrated in FIGS. 1 to 9.

Referring to FIG. 11, the access point may include a processor 1101, a transceiver 1103, and memory 1105. In the disclosure, the processor 1101 may be defined as a circuit or application-specific integrated circuit, or at least one processor. The processor 1101 may be referred to as a controller.

The processor 1101 may control the overall operation of the access point according to the embodiments proposed in the disclosure. Specifically, the processor 1101, for example, may control operation of the access point illustrated in FIGS. 1 to 9.

The transceiver 1103 may transmit or receive a signal to or from a station or another access point.

The memory 1105 may store at least one piece of information among information transmitted or received via the transceiver 1103 and information generated by the processor 1101.

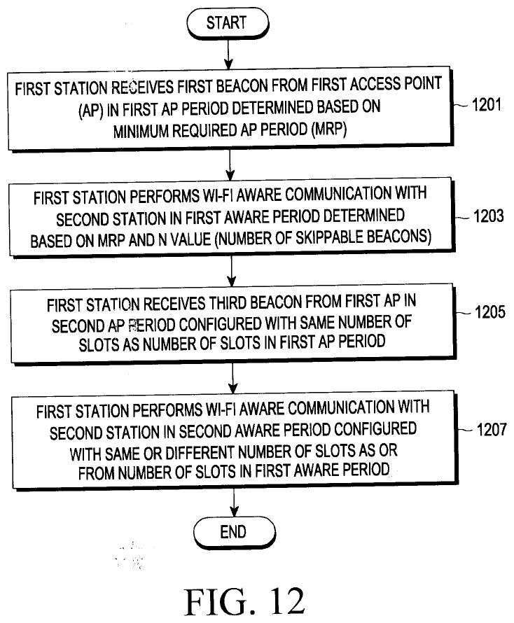

FIG. 12 is a diagram illustrating an operation method of a station according to an embodiment of the disclosure.

Referring to FIG. 12, in operation 1201, a first station may receive a first beacon from a first access point (AP) during a first AP period determined based on a minimum required AP period (MRP).

In operation 1203, the first station may perform Wi-Fi Aware communication with a second station in a first aware period determined based on the MRP and an N value (the number of skippable beacons).

In operation 1203, the first station may receive a third beacon from the first AP in a second AP period configured with the same number of slots as the number of slots configured in the first AP period.

In operation 1205, the first station may perform Wi-Fi Aware communication with the second station in a second aware period configured with the same or different number of slots as or from the number of slots configured in the first aware period.

Time resource scheduling for an AP period and/or Wi-Fi Aware period according to embodiments of the disclosure may be performed based on a station, an access point, and/or a network device. According to an embodiment, the station may directly perform time resource scheduling for an AP period and/or Wi-Fi Aware period, and may perform communication based on the time resource scheduling. According to an embodiment, the station may receive information related to time resource scheduling for an AP period and/or Wi-Fi Aware period from the access point (or network device), and may perform communication based on the time resource scheduling.

According to an embodiment, a first station and/or a second station may adjust a time resource for an AP period and/or Wi-Fi Aware period (e.g., adjust the number of slots allocated to an AP period and/or Wi-Fi period) by using at least one of exchanged QoS information and TSF information.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A first station performing Wi-Fi Aware communication, the first station comprising:
a transceiver; and
a processor,
wherein the processor is configured to:
receive a first beacon in a first AP period in which the first station communicates with a first access point (AP), and
communicate with a second station in a first aware period in which the first station performs Wi-Fi Aware communication,
wherein the first AP period is determined based on a minimum required AP period (MRP), and
wherein the MRP is determined based on the first beacon, a second beacon received by the second station from a second AP, and a margin slot.

2. The station of claim 1, wherein the MRP is determined based on a difference in time between a transmission point for the first beacon and a transmission point for the second beacon.

3. The station of claim 1, wherein the margin slot is determined based on a time required by the first station to perform channel switching between an AP channel and a Wi-Fi Aware channel.

4. The station of claim 1,
wherein the first aware period is determined based on the MRP and an N value, and
wherein the N value is the number of beacons skippable by the first station among a plurality of beacons transmitted from the first AP during a configured time period.

5. The station of claim 4, wherein the N value is configured based on a connection policy of the first AP or the second AP.

6. The station of claim 4,
wherein the number of slots in a round including the first AP period and the first aware period is determined based on the N value, and
wherein the number of slots in the first aware period is determined based on the number of slots in the round and the MRP.

7. The station of claim 1, wherein the processor is configured to:
receive a third beacon in a second AP period in which the first station communicates with the first AP; and
communicate with the second station in a second aware period in which the first station performs Wi-Fi Aware communication.

8. The station of claim 7,
wherein the first AP period and the second AP period are configured as a first slot value, and
wherein the first aware period and the second aware period are configured as a second slot value.

9. The station of claim 7,
wherein the first AP period and the second AP period are configured as a first slot value,
wherein the first aware period is configured as a second slot value, and
wherein the second aware period is configured as a third slot value.

10. The station of claim 9, wherein the second slot value and the third slot value are determined based on a beacon shifting value for at least one beacon.

11. A method of a first station for performing Wi-Fi Aware communication, the method comprising:
receiving a first beacon in a first AP period in which the first station communicates with a first access point (AP); and
communicating with a second station in a first aware period in which the first station performs Wi-Fi Aware communication,
wherein the first AP period is determined based on a minimum required AP period (MRP), and
wherein the MRP is determined based on the first beacon, a second beacon received by the second station from a second AP, and a margin slot.

12. The method of claim 11, wherein the MRP is determined based on a difference in time between a transmission point for the first beacon and a transmission point for the second beacon.

13. The method of claim 11, wherein the margin slot is determined based on a time required by the first station to perform channel switching between an AP channel and a Wi-Fi Aware channel.

14. The method of claim 11,
wherein the first aware period is determined based on the MRP and an N value, and
wherein the N value is the number of beacons skippable by the first station among a plurality of beacons transmitted from the first AP during a configured time period.

15. The method of claim 14, wherein the N value is configured based on a connection policy of the first AP or the second AP.
